(19) United States
(12) Patent Application Publication
(10) Pub. No.: US 2007/0216329 A1
(43) Pub. Date: Sep. 20, 2007

(54) Motor control apparatus, motor control method, hard disk drive testing apparatus, and storage device manufacturing method

(75) Inventor: Tsutomu Sasaki, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/449,797

(22) Filed: Jun. 9, 2006

(30) Foreign Application Priority Data
Mar. 15, 2006 (JP) 2006-070398

(51) Int. Cl. H02P 3/12

(52) U.S. Cl. 318/379

(57) ABSTRACT

A motor control apparatus that drives and controls a holeless DC motor is disclosed. The motor control apparatus includes a breaking part configured to break the DC holeless motor, a detection part configured to detect whether the DC holeless motor is in a near halt rotation state, and a forced stopping part configured to forcibly stop rotation of the DC holeless motor when the detection part detects that the DC holeless motor is in the near halt rotation state.

### BACKGROUND OF THE INVENTION

1. Field of the Invention

The present invention relates to a motor control apparatus and a motor control method for forcibly stopping a rotating element, a hard disk drive testing apparatus, and a method for manufacturing a storage device.

2. Description of the Related Art

In a hard disk drive, for example, a three-phase brushless holeless DC motor (referred to as DCM hereinafter) may be used as a motor for rotating a magnetic disk. The DCM does not include a sensor for detecting a rotor position, and therefore, the DCM may monitor the voltages of U-phase, V-phase, and W-phase coil outputs that are generated during motor rotation, and detect the voltage cross point of each phase in order to detect the rotor position.

Normally, short breaking that involves generating an induced voltage by cutting excitation and short-circuiting each phase is used to stop high-speed rotation of the DCM. Also, a torque in a reverse direction with respect to the rotating direction of the coil is generated so that the rotation of the motor may be stopped.

However, when the rotational speed of the DCM decreases, the generated voltage also decreases so that the reverse torque is hardly generated, and thus, the motor may continue to rotate under inertia for a relatively long period of time. In turn, techniques have been proposed involving monitoring the induced voltages of the U-phase, V-phase, and W-phase coils at predetermined intervals, and forcibly inducing excitation to actively apply the reverse torque to the coils of the DCM (e.g., see Japanese Laid-Open Patent Publication No. 10-98894 and Japanese Laid-Open Patent Publication No. 2004-229462).

It is noted that a hard disk drive includes a base plate, a DCM, a medium (e.g., magnetic disk), a head, an actuator, a VCM, and a cover, for example. The hard disk drive is currently manufactured using an automatic assembly line to enable mass production of approximately 1,000,000 products per month, for example. The assembly process for manufacturing the hard disk drive may be divided into a medium deposition step, a clamping step for clamping the medium to the DCM, an actuator/VCM mounting step, and a cover screw fastening step, for example. It is noted that after the medium clamping step, the clamped medium is rotated at high-speed, and the surface deviation of the clamped medium is measured in order to determine the assembly precision. After the precision measurement, a breaking process may be performed on the DCM in the manner described above.

In view of realizing mass production of the hard disk drive, the time required for stopping the rotation of the DCM may be a factor prolonging the assembly cycle time. By stopping the DCM through short breaking and reverse breaking using the reverse torque as is described above, the time required for stopping the DCM may be reduced compared to a case in which other methods are used for breaking the DCM. However, as is described above, short breaking is hardly effective when the DCM is slowed down to a near halt, and reverse breaking cannot completely stop the DCM since it involves applying a reverse torque.

It is noted that the DCM has to be completely stopped before moving on to the actuator/VCM mounting step after the assembly precision measurement. This is because if the manufacturing process moves on to the next step while the DCM is still rotating under inertia, the surge voltage generated from the DCM upon detaching probe pins may damage electrodes, and movement by the rotational inertia force may not be stable.

As can be appreciated, in conventional motor controlling techniques, the DCM cannot be completely stopped so that it takes a relatively long period of time before the DCM is completely stopped from a near halt, and thereby, the assembly cycle time cannot be adequately reduced.

### SUMMARY OF THE INVENTION

According to embodiments of the present invention, a motor control apparatus and a motor control method are provided that can reduce the time required for completely stopping a DC holeless motor from a near halt rotation state. According to other embodiments of the present invention, a hard disk testing apparatus and a method for manufacturing a storage device are provided.

According to one specific embodiment of the present invention, a motor control apparatus that drives and controls a holeless DC motor is provided, the motor control apparatus including:

a breaking part configured to break the DC holeless motor;

a detection part configured to detect whether the DC holeless motor is in a near halt rotation state; and

a forced stopping part configured to forcibly stop rotation of the DC holeless motor when the detection part detects that the DC holeless motor is in the near halt rotation state.

According to another specific embodiment of the present invention, a motor control apparatus is provided that controls a DC motor including a plurality of phase coils, the motor control apparatus comprising:

a first controller configured to short-circuit the plurality of phase coils during a first period;

a second controller configured to supply a current to the plurality of phase coils and induce generation of a reverse direction torque during a second period following the first period; and

a third controller configured to apply a predetermined exciting current to at least one of said phase coils for a predetermined time, during a third period following the second period, thereby stopping rotation of the DC motor.

According to a preferred embodiment, the third controller is configured to apply the predetermined exciting current to two of the phase coils.

According to another specific embodiment of the present invention, a motor control apparatus that drives and controls a DC holeless motor including a U-phase coil, a V-phase coil, and a W-phase coil is provided, the motor control apparatus including:

a short breaking part configured to apply short breaking on the DC holeless motor when a rotation stop command is input;

a first detection part configured to detect a reverse torque supplying start time;

a reverse torque generating part configured to supply a current to the U-phase coil, the V-phase coil, and the W-phase coil and induce generation of a reverse direction torque when the first detection part detects the reverse torque supplying start time;

a second detection part configured to detect whether the DC holeless motor is in a near halt rotation state; and

a forced stopping part configured to forcibly stop rotation of the DC holeless motor when the second detection part detects that the DC holeless motor is in the near halt rotation state.

According to a preferred embodiment, the first detection part is configured to detect the reverse torque supplying start time based on the time period elapsed from the time the rotation stop command is input.

According to another preferred embodiment, the first detection part is configured to detect the time the rotation of the DC holeless motor equals to 50% of a steady-state rotation of the DC holeless motor as the reverse torque supplying start time.

According to another preferred embodiment, a short breaking process realized by the short breaking part, a reverse torque generating process realized by the reverse torque generating part, and an inertial rotation process involving stopping the current supply to the U-phase coil, the V-phase coil, and the W-phase coil are alternatingly performed during the time after the reverse torque supplying start time is detected and before the near halt rotation state of the DC holeless motor is detected.

According to another specific embodiment of the present invention, a motor control method for driving and controlling a DC motor including a first phase coil, a second phase coil and a third phase coil is provided, the motor control method comprising the steps of:

short-circuiting the first phase coil, the second phase coil, and the third phase coil for a first period;

supplying a current to the first phase coil, the second phase coil, and the third phase coil, and inducing generation of a reverse direction torque for a second period after the first period is ended; and

applying a predetermined exciting current to as least one of said first, second or third phase coils for a third period after the second period is ended.

According to another specific embodiment of the present invention, a motor control method for driving and controlling a DC holeless motor including a U-phase coil, a V-phase coil, and a W-phase coil is provided, the motor control method including the steps of:

applying short breaking on the DC holeless motor when a rotation stop command is input;

detecting a reverse torque supplying start time;

supplying a current to the U-phase coil, the V-phase coil, and the W-phase coil and inducing generation of a reverse direction torque when the reverse torque supplying start time is detected;

detecting whether the DC holeless motor is in a near halt rotation state; and

forcibly stopping rotation of the DC holeless motor when the DC holeless motor is detected to be in the near halt rotation state.

According to another specific embodiment of the present invention, a hard disk drive testing apparatus is provided that includes:

a DC holeless motor configured to rotate a hard disk upon testing the hard disk; and

a motor control apparatus configured to drive and control the DC holeless motor;

wherein the motor control apparatus includes
a breaking part configured to break the DC holeless motor;
a detection part configured to detect whether the DC holeless motor is in a near halt rotation state; and
a forced stopping part configured to forcibly stop rotation of the DC holeless motor when the detection part detects that the DC holeless motor is in the near halt rotation state.

According to another specific embodiment of the present invention, a hard disk drive testing apparatus is provided that includes:

a DC holeless motor including a U-phase coil, a V-phase coil, a W-phase coil, which DC holeless motor is configured to rotate a hard disk upon testing the hard disk; and

a motor control apparatus configured to drive and control the DC holeless motor;

wherein the motor control apparatus includes
a short breaking part configured to apply short breaking on the DC holeless motor when a rotation stop command is input;
a first detection part configured to detect a reverse torque supplying start time;
a reverse torque generating part configured to supply a current to the U-phase coil, the V-phase coil, and the W-phase coil and induce generation of a reverse direction torque when the first detection part detects the reverse torque supplying start time;
a second detection part configured to detect whether the DC holeless motor is in a near halt rotation state; and
a forced stopping part configured to forcibly stop rotation of the DC holeless motor when the second detection part detects that the DC holeless motor is in the near halt rotation state.

According to another specific embodiment of the present invention, a method for manufacturing a storage device including a recording medium and a motor that rotates the recording medium is provided, the method including the steps of:

rotating the motor;

performing a short breaking process on the motor;

exciting the motor and inducing the motor to generate a reverse torque when a rotation speed of the motor reaches a value that is less than or equal to a first predetermined value;

forcibly stopping rotation of the motor when the rotation speed of the motor reaches a value that is less than or equal to a second predetermined value which second predetermined value is less than the first predetermine value; and

performing one or more processes on the storage device after the motor is stopped.

According to another specific embodiment of the present invention, a motor drive control method for driving and controlling a motor including plural excitation phases is provided, the method including the steps of:

short-circuiting the excitation phases while the motor is rotating;

exciting the motor and inducing the motor to generate a reverse rotation direction torque when a rotation number of the motor reaches a first predetermined value; and

performing forced excitation for a predetermined time period in accordance with a predetermined excitation pattern when the rotation number of the motor reaches a second predetermined value which second predetermined value is less than the first predetermined value.

### BRIEF DESCRIPTION OF THE DRAWINGS

FIG. 1 is a diagram showing a functional configuration of a motor control apparatus according to an embodiment of the present invention;

FIG. 2 is a diagram showing a configuration of a three-phase-six-pole DC motor;

FIG. 3 is a diagram illustrating excitation patterns of the DC motor;

FIG. 4 is a block diagram showing a hardware configuration of the motor control apparatus;

FIG. 5 is a perspective view of a hard disk drive testing apparatus according to an embodiment of the present invention;

FIG. 6 is a diagram illustrating a short breaking mode that is realized by the motor control apparatus;

FIG. 7 is a graph showing a relationship between the motor rotation number and the rotation mode upon executing a breaking process;

FIG. 8 is a flowchart showing the basic process steps of the breaking process;

FIG. 9 is a timing chart showing relative timings of a detection timing signal, a phase signal, excitation switching signals, and the breaking control process in the short breaking mode;

FIG. 10 is a timing chart illustrating timings of the excitation switching signals before reaching the time for switching from a reverse torque mode to a forced stopping mode; and

FIG. 11 is a timing chart illustrating timings of the excitation switching signals at a point where the forced stopping mode breaking process is started.

### DESCRIPTION OF THE PREFERRED EMBODIMENTS

In the following, preferred embodiments of the present invention are described with reference to the accompanying drawings.

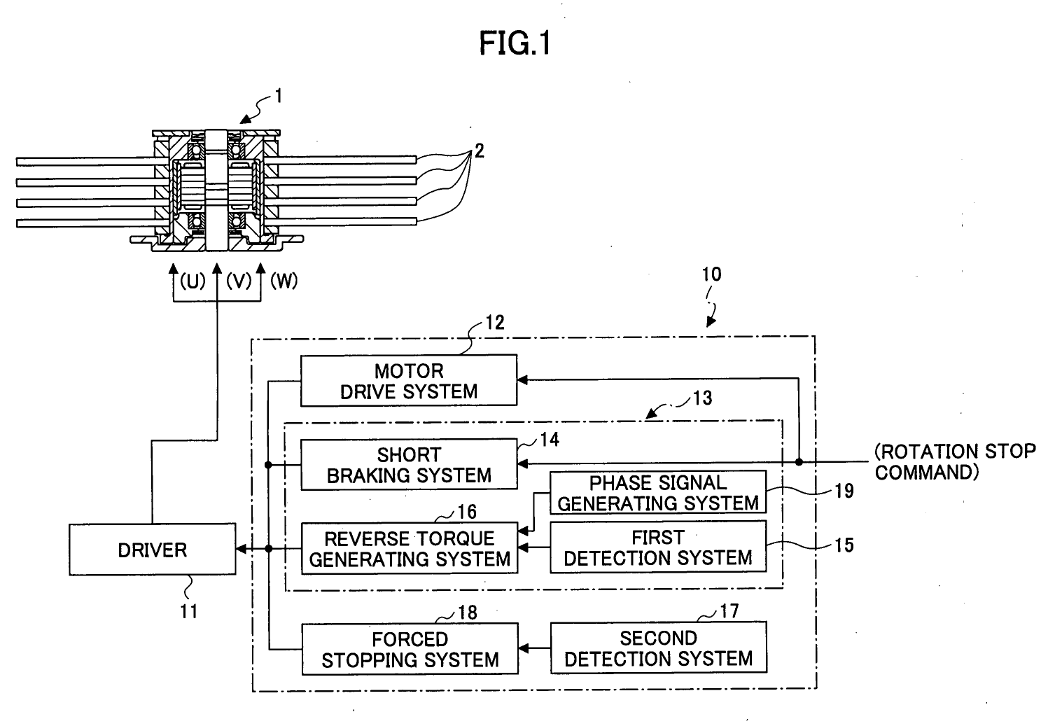

FIG. 1 is a diagram showing a configuration of a motor control apparatus according to an embodiment of the present invention. In the following, an example is described in which the motor control apparatus of the present embodiment is used for measuring the assembly precision of a hard disk drive which measuring process is performed after a medium clamping step of clamping a medium to a motor of the hard disk drive.

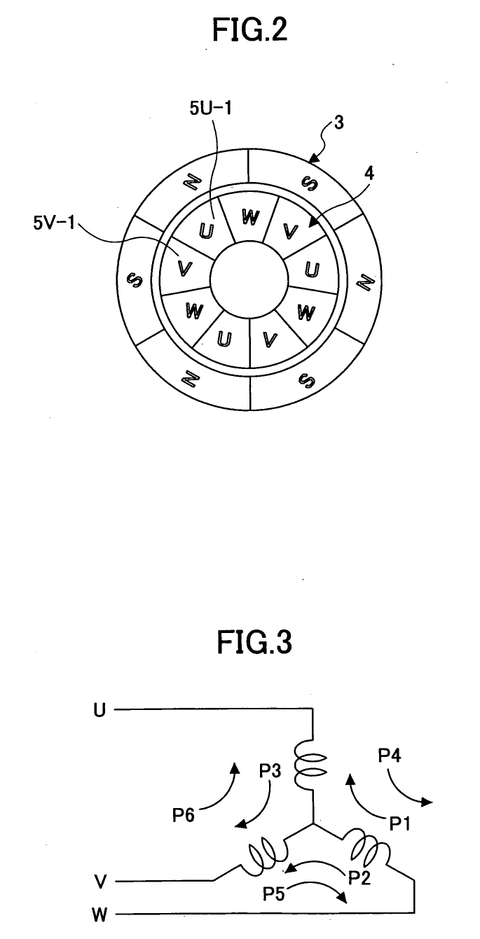

In the present example, a three-phase DC brushless holeless motor 1 (referred to as DCM hereinafter) is used as the motor of the hard disk drive. As is shown in FIG. 2, the DCM 1 may be a three-phase six-pole motor including a permanent magnet of the six poles arranged at a rotor 3, and drive coils 5U, 5V, 5W of the three phases (i.e., excitation phases of the three phases) arranged at a stator 4 disposed within the rotor 3.

FIG. 3 is a diagram illustrating six excitation patterns P1-P6 for exciting the drive coils 5U, 5V, and 5W. A control apparatus 10 is configured to switch the excitation currents being supplied to the drive coils 5U, 5V, and 5W, and in this way, the DCM 1 may be activated to rotate at a steady pace, for example.

As is described above, in the present example, the control apparatus 10 is used for measuring the assembly precision of a hard disk drive which measuring process is performed after a medium clamping step of clamping the medium of the hard disk drive to the DCM 1. As is shown in FIG. 1, the DCM 1 has plural magnetic disks 2 clamped thereto. FIG. 5 is a perspective view of a hard disk drive testing apparatus 6 that includes the control apparatus 10 of the present embodiment and is configured to measure the assembly precision of a hard disk drive. The assembly precision measurement is performed on the hard disk drive after the magnetic disks 2 are clamped to the DMC 1 as is shown in FIG. 5 (i.e., surface deviations of the clamped magnetic disks 2 are measured while the DCM 1 is rotated in this state).

Also, in the present example, the DCM 1 corresponds to a holeless motor that does not include a hole member for rotation detection. With such an arrangement, although cost reduction may be realized, the rotor 3 cannot be directly detected. Accordingly, the DCM 1 is configured to perform rotation detection by monitoring the voltages generated at the drive coils 5U, 5V, and 5W during rotation of the motor and detecting the respective voltage cross points of the phases.

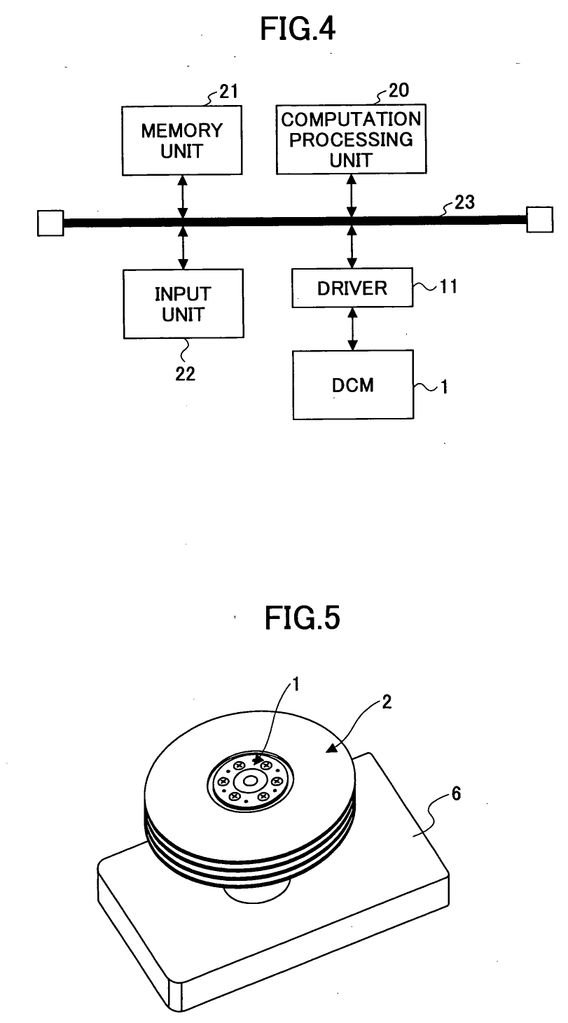

The DCM 1 having the above-described configuration is driven and controlled by the control apparatus 10. FIG. 4 is a block diagram showing a hardware configuration of the control apparatus 10. The control apparatus 10 may be a microcomputer that includes a computation processing unit 20, a memory unit 21, and an input unit 22, for example. The memory unit 21 stores control processing programs that may be executed to enable the computation processing unit 20 to perform breaking processes on the DCM 1. The input unit 22 is used for inputting rotation stop commands. The computation processing unit 20 is configured to generate drive signals and control signals for the DCM 1 which drive signals and control signals are transmitted to a driver 11 via a bus line 23. In turn, drive control and breaking processes may be performed on the DCM 1 via the driver 11.

FIG. 1 shows a functional configuration of the control apparatus 10. According to FIG. 1, the control apparatus 10 includes a motor drive system 12, a breaking system 13, a second detection system 17, and a forced stopping system 18. It is noted that in the present example, the systems 12, 13, 17, and 18 as is described above take the form of software processes that may be executed by the computation processing unit 20 based on programs stored in the memory unit 21. Thus, in the present example, the computation processing unit 20 executing the breaking system 13 may embody a breaking part of a control apparatus according to an embodiment of the present invention, the computation processing unit 20 executing the second detection system 17 may embody a (second) detection part of the control apparatus, and the computation processing unit 20 executing the forced stopping system 18 may embody a forced stopping part of the control apparatus, for example. However, the present invention is not limited to the present example, and other embodiments are possible in which one or more of the above-described systems are realized by hardware, for example.

The motor drive system 21 is configured to realize a process of rotating the DCM 1 at a steady pace. Specifically, the motor drive system 12 selectively supplies an excitation current to the drive coils 5U, 5V, and 5W based on an excitation switching signal that is correlated with a steady-state rotation number to thereby drive the DCM 1 to rotate at the steady-state rotation number. It is noted that the steady-state rotation number corresponds to a predetermined rotation number (per time unit) at which the DCM 1 is rotated upon performing the assembly precision measurement on the magnetic disks 2. The steady-state rotating process on the DCM 1 may be realized through known processes, and thereby detailed descriptions thereof are omitted.

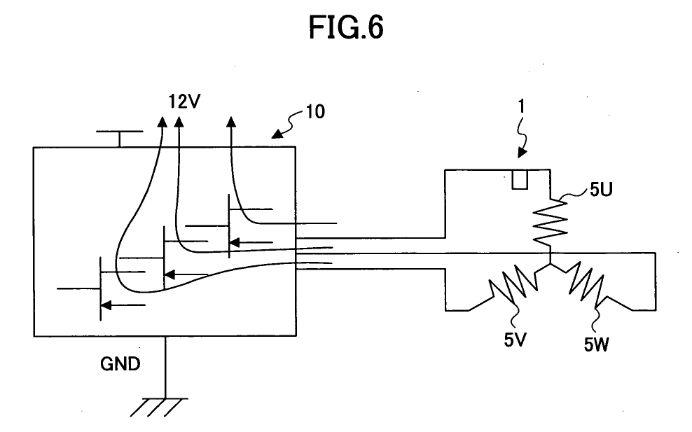

The breaking system 13 includes a short breaking system 14, a first detection system 15, and a reverse torque generating system 16. As is shown in FIG. 6, the short breaking system 14 arranges the drive coils 5U, 5V, and 5W to be conducting (i.e., to be short-circuited to ground GND or a power source), and controls the DCM 1 to stop rotating by its self-generated power. The short breaking system 14 is configured to be activated when a rotation stop command is input from the input unit 22.

The reverse torque generating system 16 is configured to break the DCM 1 by supplying a current to the drive coils 5U, 5V, and 5W so as to induce the drive coils 5U, 5V, and 5W to generate a reverse torque (such a breaking process being referred to as ‘reverse torque mode breaking’ hereinafter). The reverse torque generating system 16 is configured to be activated when the first detection system 15 detects that the rotation number of the DCM 1 is reduced to 50% of the steady-state rotation number. It is noted that the reverse torque applying time is determined based on a phase signal that is generated by a phase signal generating system 19, the details of which are described below.

The forced stopping system 18 is configured to forcibly stop the rotation of the DMC 1 when the second detecting system 17 detects that the DCM 1 has reached a near halt (e.g., 27.12 rpm) by forcibly supplying a current to two of the drive coils 5U, 5V, and/or 5W for a predetermined period of time according to one of the six patterns P1-P6 as is described above (e.g., P3: U→V) to induce excitation. It is noted that the forced breaking time (forced excitation time) in this case may be approximately several hundred milliseconds, for example.

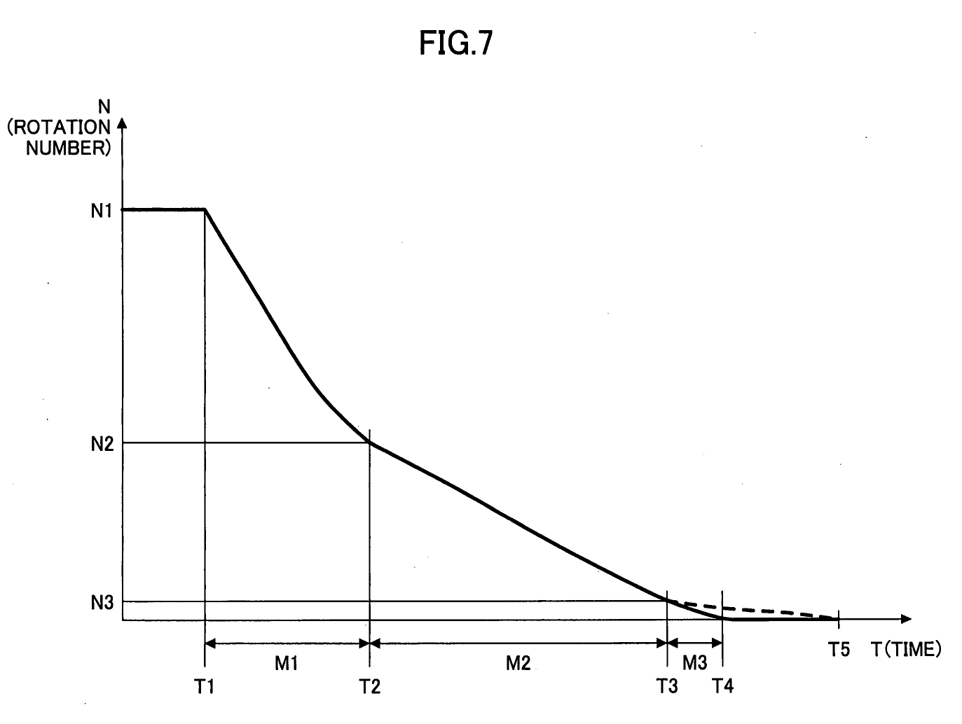

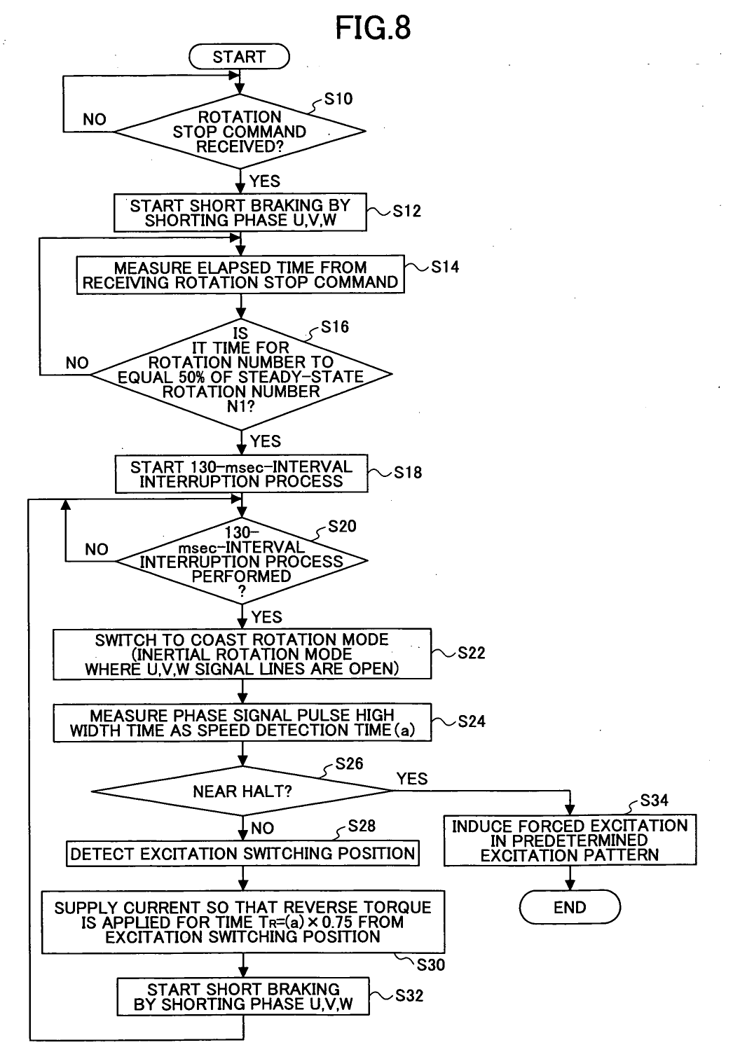

In the following, the breaking process performed by the control apparatus 10 for stopping the DCM 1 is described with reference to FIGS. 7 and 8. FIG.7 is a diagram showing the change in the rotation number of the DCM 1 in relation to time after the breaking process is started by the control apparatus 10. FIG. 8 is a flowchart showing process steps of the breaking process performed by the control apparatus 10.

First basic process steps of the breaking process performed by the control apparatus 10 are described with reference to FIG. 7. The breaking process performed by the control apparatus 10 has three processing modes, namely, a short breaking mode M1, a reverse torque mode M2, and a forced stopping mode M3.

The short breaking mode M1 corresponds to a processing stage from a time T1 at which a rotation stop command is issued to a time T2 at which the rotation number N of the DCM 1 is reduced to a rotation number N2 that is equal to 40-50% (50% in the present example) of the steady-state rotation number N1 of the DCM 1. As is described above, the first detecting system 15 is configured to detect that the rotation number N of the DCM 1 has reached the rotation number N2 equal to 40-50% of the steady-state rotation number N1.

The torque mode M2 corresponds to a processing stage from the time T2 at which the rotation number of the DCM 1 reaches the rotation number N2 to a time T3 at which the rotation number N of the DCM 1 is reduced to a near halt rotation number N3 (e.g., 27.12 rpm). As is described above, the second detecting system 17 is configured to detect that the rotation number N of the DCM 1 has reached the near halt rotation number N3.

The forced stopping mode M3 corresponds to a processing stage from the time T3 at which the rotation number N of the DCM 1 reaches the near halt rotation number N3 to a time T4 at which the DCM 1 is stopped.

In the short breaking mode M1, the computation processing unit 20 activates the short breaking system 14 so that short breaking may be applied to the DCM 1. As is described above, short breaking involves stopping motor rotation with the self-generated power of the motor. Therefore, the DCM 1 may be efficiently breakd through short breaking when the rotation number N of the DCM 1 is relatively large (i.e., when the DCM 1 is rotating at high-speed). Accordingly, short breaking is used for putting a break on the DCM 1 right after a rotation stop command is issued, while the motor rotation number is relatively large.

Then, in the reverse torque mode M2, short breaking realized by the short breaking system 14 and reverse torque breaking realized by the reverse torque generating system 16 are used. The reverse torque generating system 16 is activated after the rotation number of the DCM 1 starts decreasing. It is noted that when the reverse torque generating system 16 is operated while the rotation number of the DCM 1 is still high, a high level of noise may be generated, and heat at a high temperature may be generated. However, since reverse torque breaking realized by the reverse torque generating system 16 is capable of maintaining a constant breaking force regardless of the rotation number N of the DCM 1, such reverse breaking may be effectively used in the reverse breaking mode M2 where the rotation number N of the DCM 1 is decreasing.

Then, in the forced stopping mode M3, a current is forcibly supplied for a predetermined period of time by the forced stopping system 18 in accordance with a selected one (e.g., P3: U→V) of the six excitation patterns P1-P6. For example, in FIG. 2, if a current is supplied from the drive coil 5U-1 to the drive coil 5V-1 so that magnetic excitations are induced between the drive coil 5U-1 and the S pole, and the drive coil 5V-1 and the N pole, the rotor 3 rotating at a low speed rotation number may be forcibly stopped by the magnetic attraction force generated by the magnetic excitation.

In the following, basic process steps of the breaking process are described with reference to FIG. 8.

In step S10, the computation processing unit 20 determines whether a rotation stop command is input from the input unit 22. When the computation processing unit 20 determines in step S10 that a rotation stop command has been input, it terminates the steady-state rotation process of the DCM 1 that is realized by the motor drive system 12, and activates the short breaking system 14. In this way, the control apparatus 10 enters the short breaking mode M1.

In the short breaking mode M1, the computation processing unit 20 short-circuits the drive coils 5U, 5V, and 5W so that a short breaking process on the DCM 1 may be started (step S12). The computation processing unit 20 also measures the elapsed time from the time Ti at which the rotation stop command has been input (step S14).

In step S16, the computation processing unit 20 monitors the time measured by the short breaking system 14 to determine whether a predetermined time has elapsed for the rotation number of the DCM 1 to be reduced to the rotation number N2 equal to 50% of the steady-state rotation number N1 (N2=N1/2). It is noted that this predetermined time corresponds to a value that is obtained beforehand through testing, for example, and is stored in the memory unit 21. It is noted that the process step S16 may be realized by the first detection system 15 of FIG. 1 according to a preferred embodiment.

As can be appreciated from the above descriptions, in the present example, the point at which the rotation number N of the DCM 1 reaches the rotation number N2 is determined based on the elapsed time from the time T1 at which the rotation stop command is issued rather than directly measuring the rotation number N of the DCM 1. In the following, the reason why such a measure is taken is explained. As is described above, the DCM 1, which corresponds to a holeless motor, is configured to detect the position of the rotor 3 by monitoring the voltages that are generated at the drive coils 5U, 5V, and 5W during motor rotation; however, when all the drive coils 5U, 5V, and 5W are short-circuited, the generated voltages of the drive coils may not be monitored so that rotation detection cannot be performed.

It is noted that the present invention is not limited to using the above-described process step for determining the point at which the rotation number N of the DCM 1 reaches the rotation number N2, and other detection means may be used such as the use of a signal for detecting the rotation number of the DCM 1.

When the computation processing unit 20 determines in step S16 that the predetermined time has elapsed for the rotation number N of the DCM 1 to reach the rotation number N2, namely, when it is determined that the rotation number N of the DCM 1 has decreased to the rotation number N2 equal to 50% of the steady-state rotation number N1, the control apparatus 10 is switched to the reverse torque mode M2.

Specifically, when a positive determination (YES) is made in step S16, the process moves on to step S18 where the computation processing unit 20 performs a 130-msec-interval interruption process. In step S20, the computation processing unit 20 monitors whether the 130-msec-interval interruption process is performed, and moves on to step S22 upon determining that the 130-mesec-interval interruption process is performed.

In step S22, the computation processing unit 20 sets the rotation of the DCM 1 to coast mode. Coast mode refers to a mode in which the drive coils 5U, 5V, and 5W are electrically open and the memory unit 21 rotates under inertia. It is noted that the rotation of the DCM 1 under the coast mode is referred to as coast rotation.

Then, in step S24, the time of the high-level width of a phase signal pulse as a speed detection time (a) is measured. It is noted that the phase signal is used to control the rotation of the DCM 1 and is generated by a phase signal generating system 19 (see FIG. 1).

Specifically, the phase signal generating system 19 monitors the reverse electromotive force of the DCM 1 (i.e., electromotive force generated through coast rotation of the drive coils 5U, 5V, and 5W that are not supplied with a drive current) at the U-phase, the V-phase, and the W-phase, and generates a phase signal based on the monitoring results. The generated phase signal corresponds to a rectangular signal, and in the case of using the DCM 1, which is a three-phase-six-pole DC motor, the three pulses are arranged to be generated in one motor rotation.

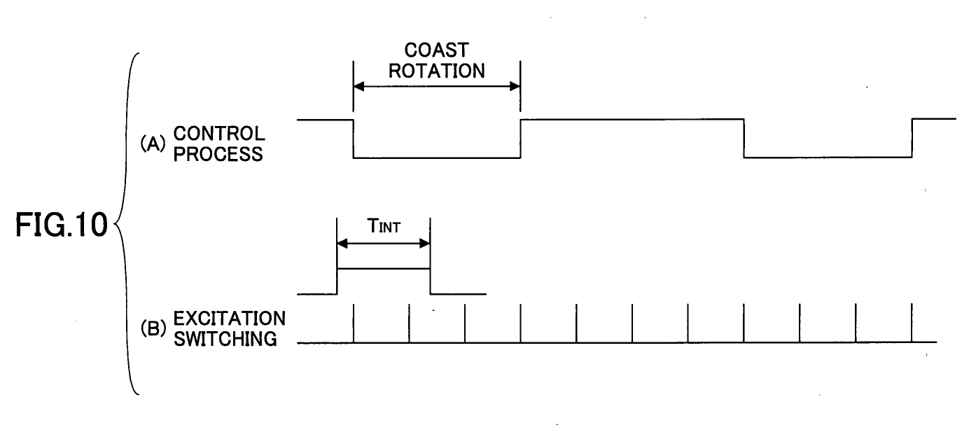

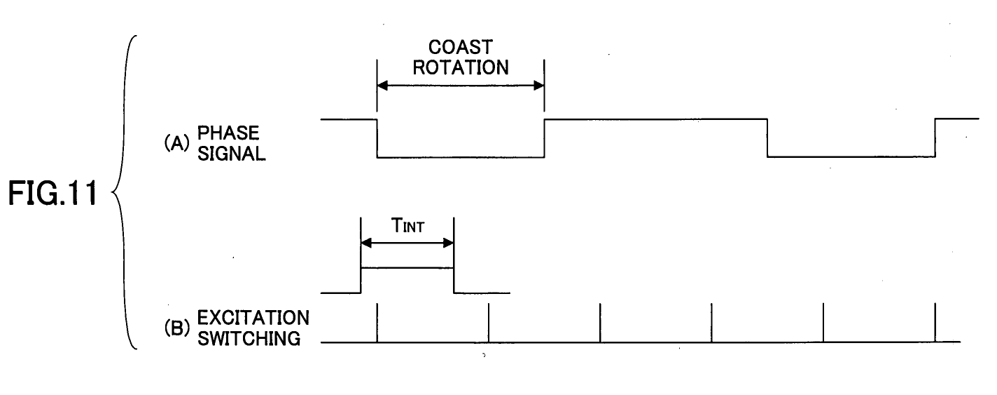

Then, in step S26, a determination is made as to whether the rotation of the DCM 1 is close to a halt. The detection of a near halt rotation state of the DCM 1 may be realized using an excitation switching signal according to one embodiment. Such detection process is described in detail below with reference to FIGS. 10 and 11. The excitation switching signal is used to determine the timing at which a drive current is to be supplied to the drive coils 5U, 5V, and 5W, and is supplied from a resistor of a rotation controlling IC (not-shown).

The excitation switching signal is polled when the DCM 1 is in coast rotation mode and reverse excitation is performed; on the other hand, the excitation switching signal is not polled when short breaking is performed and the drive coils 5U, 5V, and 5W are short-circuited. Also, it is noted that the excitation switching signal is in correlation with the rotation angular speed of the DCM 1 so that the rotation angular speed of the DCM 1 becomes faster as the interval of the excitation switching signal is shortened, and the rotation angular speed of the DCM 1 becomes slower as the interval of the excitation switching signal is lengthened. In this way, the rotation state (speed) of the DCM 1 may be detected.

In the present example, a detection reference time T_{INT} is set to 122.88 msec, and when the excitation switching signal is generated twice or more within the detection reference time TINT (see FIG. 10), it may be determined that the rotation of the DCM 1 is faster than the near halt rotation speed (e.g., 27.12 rpm) and the DCM 1 has not yet reached a near halt rotation state. On the other hand, when the excitation signal is generated no more than once within the detection reference time TINT (see FIG. 11), it may be determined that the rotation of the DCM 1 is slower than the near halt rotation speed (e.g., 27.12 rpm) and the DCM 1 is therefore in a near halt rotation state.

As can be appreciated from the above descriptions, when a negative determination (NO) is made in step S26, the computation processing unit 20 determines that the DCM 1 has not yet reached a near halt rotation state and maintains the reverse torque mode M2. It is noted that step S26 may be realized by the second detection system 17 of FIG. 1 according to an embodiment.

When a negative determination is made in step S26, the process moves on to step S28 in which an excitation switching position is monitored. In the present example, the excitation switching position is determined based on the excitation switching signal. Specifically, in the reverse torque mode M2, the excitation switching signal supplied from the resistor of the rotation controlling IC as is described above is generated according to the reverse torque mode M2.

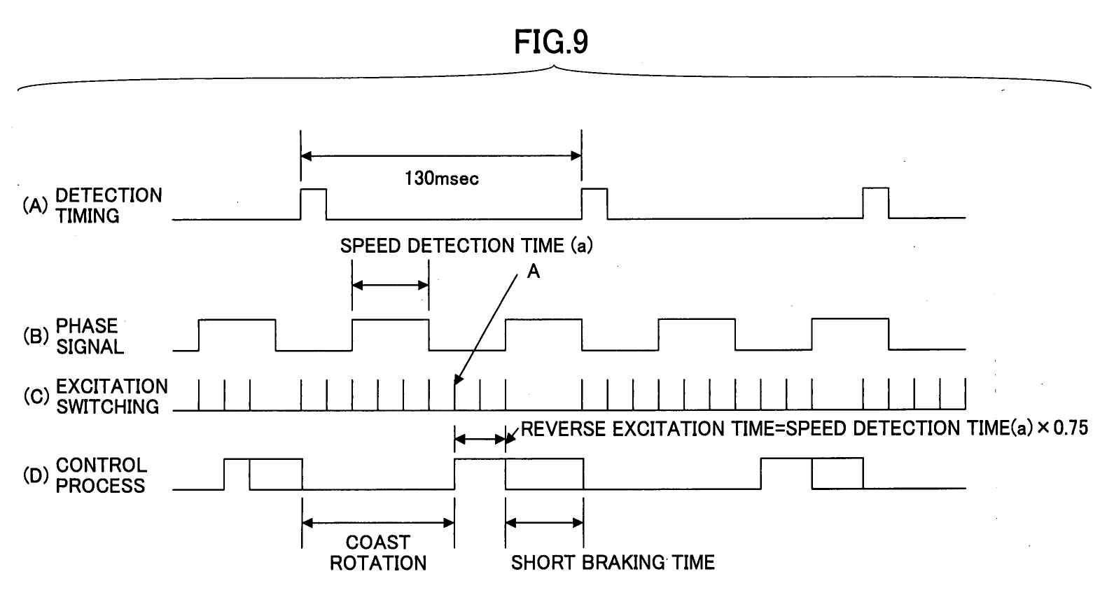

It is noted that a reverse excitation position detection signal (e.g., a reverse rotation signal embedded within a normal rotation signal for the DCM 1) is embedded at the reverse torque generating system activation timing position of the excitation switching signal according to the reverse torque mode M2. In the present example, the excitation switching signal as is indicated by arrow A in FIG. 9 corresponds to a reverse excitation position detection signal. FIG. 9 is a timing chart illustrating relative timings of a detection timing signal (A), a phase signal (B), excitation switching signals (C), and the breaking control process (D).

When the computation processing unit 20 detects that the reverse excitation position detection signal is output in step S28, the process moves on to step S30. In step S30, the computation processing unit 20 activates the reverse torque generating system 16 to perform reverse torque mode breaking on the DCM 1. Specifically, the computation processing unit 20 computes the reverse excitation time (i.e., time during which the reverse torque mode breaking is to be performed) based on the speed detection time (a) obtained in step S24, and supplies a current to the drive coils 5U, 5V, and 5W so that the reverse torque may be applied to the DCM 1 during this reverse excitation time.

In the present example, the reverse excitation time T_{R} is obtained by the formula T_{R}=a×0.75. As is described above, since the speed detection time (a) is obtained according to the rotation state of the DCM 1, the reverse torque mode breaking is also performed for a time according to the rotation state of the DCM 1. Then, in step S32, the computation processing unit 20 activates the short breaking system 14 so that short breaking is performed on the DCM 1 for a predetermined period of time.

As is shown in FIG. 9, in the present example, detection timing signals are output at 130-msec-intervals, and coast rotation, reverse torque mode breaking, and short breaking are alternatingly performed within each 130-msec interval of the detection timing signal. In this way, the rotation number N (rotation angular speed) of the DCM 1 may be reduced by performing the steps S28 through S32 in the reverse torque mode M2 as is shown in FIG. 7.

When it is determined in step S26 that the DCM 1 is in a near halt rotation state, the process moves on to step S34 in which the computation processing unit 20 switches the control apparatus 10 to the forced stopping mode M3.

In step S34, the computation processing unit 20 performs forced excitation with a given excitation pattern. Specifically, the forced excitation is realized by forcibly-applying a current for a predetermined time period in one (e.g., P3: U→V) of the six excitation patterns P1-P6 (see FIG. 3). In this way, the rotor 3 rotating at a low speed (near halt rotation) may stop where the poles of the permanent magnet arranged within the rotor 3 are in stable states with respect to the polarity of the magnetic fields generated by the drive coils 5U and 5V (i.e. where the N pole and the S pole oppose each other). It is noted that the forced breaking time (i.e., time period from time T3 to time T4) may be around several hundred milliseconds, for example.

As can be appreciated from the above descriptions, in the present example, the forced stopping system 18 is activated to forcibly stop the DCM 1 when it is detected that the DCM 1 is in a near halt rotation state. In this way, the time required for stopping the DCM 1 may be reduced.

Specifically, in a case where the forced stopping system 18 is not used, the rotor 3 continues to rotate at low speed even after it reaches the near halt rotation state as is indicated by the broken line in FIG. 7. Therefore, a time T5 at which the DCM 1 is completely stopped in this case is later than the time T4 at which the DCM 1 is completely stopped where forced breaking is used. In other words, more time is needed for the DCM 1 to completely stop in the case where forced breaking is not used.

In the present example, the time period from the time T3 at which the DCM 1 reaches the near halt rotation state to the time T4 at which the DCM 1 completely stops may be reduced, and therefore, the DCM 1 may be stopped in a shorter period of time from the time it is breakd from the steady-state rotation mode. Also, by using the control apparatus 10 of the present embodiment in a hard disk drive testing apparatus, the assembly cycle time for manufacturing a hard disk drive may be reduced.

Further, the present invention is not limited to the above-described embodiments, and variations and modifications may be made without departing from the scope of the present invention.

The present application is based on and claims the benefit of the earlier filing date of Japanese Patent Application No. 2006-070398 filed on Mar. 15, 2006, the entire contents of which are hereby incorporated by reference.

What is claimed is:

1. A motor control apparatus that drives and controls a holeless DC motor, the motor control apparatus comprising:
a breaking part configured to break the DC holeless motor;
a detection part configured to detect whether the DC holeless motor is in a near halt rotation state; and
a forced stopping part configured to forcibly stop rotation of the DC holeless motor when the detection part detects that the DC holeless motor is in the near halt rotation state.

2. A motor control apparatus that controls a DC motor including a plurality of phase coils, the motor control apparatus comprising:
a first controller configured to short-circuit the plurality of phase coils during a first period;
a second controller configured to supply a current to the plurality of phase coils and induce generation of a reverse direction torque during a second period following the first period; and
a third controller configured to apply a predetermined exciting current to at least one of said phase coils for a predetermined time, during a third period following the second period, thereby stopping rotation of the DC motor.

3. The motor control apparatus as claimed in 1, wherein:
the third controller is configured to apply the predetermined exciting current to two of the phase coils.

4. A motor control apparatus that drives and controls a DC holeless motor including a U-phase coil, a V-phase coil, and a W-phase coil, the motor control apparatus comprising:
a short breaking part configured to apply short breaking on the DC holeless motor when a rotation stop command is input;
a first detection part configured to detect a reverse torque supplying start time;
a reverse torque generating part configured to supply a current to the U-phase coil, the V-phase coil, and the W-phase coil and induce generation of a reverse direction torque when the first detection part detects the reverse torque supplying start time;
a second detection part configured to detect whether the DC holeless motor is in a near halt rotation state; and
a forced stopping part configured to forcibly stop rotation of the DC holeless motor when the second detection part detects that the DC holeless motor is in the near halt rotation state.

5. The motor control apparatus as claimed in claim 4, wherein
the first detection part is configured to detect the reverse torque supplying start time based on a time period elapsed from a time the rotation stop command is input.

6. The motor control apparatus as claimed in claim 4, wherein
the first detection part is configured to detect a time when the rotation of the DC holeless motor equals to 50% of a steady-state rotation of the DC holeless motor as the reverse torque supplying start time.

7. The motor control apparatus as claimed in claim 4, wherein
a short breaking process realized by the short breaking part, a reverse torque generating process realized by the reverse torque generating part, and an inertial rotation process involving stopping the current supply to the U-phase coil, the V-phase coil, and the W-phase coil are alternatingly performed during a time after the reverse torque supplying start time is detected and before the near halt rotation state of the DC holeless motor is detected.

8. The motor control apparatus as claimed in claim 4, wherein
the forced stopping part is configured to stop the rotation of the DC holeless motor by forcibly exciting two of the U-phase coil, the V-phase coil, and the W-phase coil.

9. The motor control apparatus as claimed in claim 4, wherein
the second detection part is configured to detect that the DC holeless motor is in the near halt rotation state when a time interval of a current switching signal used for selectively supplying the current to the U-phase coil, the V-phase coil, and the W-phase coil becomes greater than a predetermined time interval.

10. A motor control method for driving and controlling a DC motor including a first phase coil, a second phase coil and a third phase coil, the motor control method comprising the steps of:
short-circuiting the first phase coil, the second phase coil, and the third phase coil for a first period;
supplying a current to the first phase coil, the second phase coil, and the third phase coil, and inducing generation of a reverse direction torque for a second period after the first period is ended; and
applying a predetermined exciting current to as least one of said first, second, and third phase coils for a third period after the second period is ended.

11. The motor control method as claimed in 10, wherein:
the step of applying the predetermined exciting current involves exciting two of the first phase coil, the second phase coil, and the third phase coil.

12. A motor control method for driving and controlling a DC holeless motor including a U-phase coil, a V-phase coil, and a W-phase coil, the motor control method comprising the steps of:
applying short breaking on the DC holeless motor when a rotation stop command is input;
detecting a reverse torque supplying start time;
supplying a current to the U-phase coil, the V-phase coil, and the W-phase coil and inducing generation of a reverse direction torque when the reverse torque supplying start time is detected;
detecting whether the DC holeless motor is in a near halt rotation state; and
forcibly stopping rotation of the DC holeless motor when the DC holeless motor is detected to be in the near halt rotation state.

13. The motor control method as claimed in claim 12, wherein
the step of detecting the reverse torque supplying start time involves detecting the reverse torque supplying start time based on a time period elapsed from a time the rotation stop command is input.

14. The motor control method as claimed in claim 12, wherein
the step of detecting the reverse torque supplying start time involves determining a time when the rotation of the DC holeless motor equals to 50% of a steady-state rotation of the DC holeless motor as the reverse torque supplying start time.

15. The motor control method as claimed in claim 12, wherein
a short breaking process, a reverse torque generating process, and an inertial rotation process involving stopping the current supply to the U-phase coil, the V-phase coil, and the W-phase coil are alternatingly performed during a time after the reverse torque supplying start time is detected and before the near halt rotation state of the DC holeless motor is detected.

16. The motor control method as claimed in claim 12, wherein
the step of forcibly stopping the rotation of the DC holeless motor involves forcibly exciting two of the U-phase coil, the V-phase coil, and the W-phase coil.

17. The motor control method as claimed in claim 12, wherein
the step of detecting whether the DC holeless motor is in the near halt rotation state involves determining that the DC holeless motor is in the near halt rotation state when an time interval of a current switching signal used for selectively supplying the current to the U-phase coil, the V-phase coil, and the W-phase coil becomes greater than a predetermined time interval.

18. A hard disk drive testing apparatus comprising:
a DC holeless motor configured to rotate a hard disk upon testing the hard disk; and
a motor control apparatus configured to drive and control the DC holeless motor;
wherein the motor control apparatus includes
a breaking part configured to break the DC holeless motor;
a detection part configured to detect whether the DC holeless motor is in a near halt rotation state; and
a forced stopping part configured to forcibly stop rotation of the DC holeless motor when the detection part detects that the DC holeless motor is in the near halt rotation state.

19. A hard disk drive testing apparatus comprising:
a DC holeless motor including a U-phase coil, a V-phase coil, a W-phase coil, which DC holeless motor is configured to rotate a hard disk upon testing the hard disk; and
a motor control apparatus configured to drive and control the DC holeless motor;
wherein the motor control apparatus includes
a short breaking part configured to apply short breaking on the DC holeless motor when a rotation stop command is input;
a first detection part configured to detect a reverse torque supplying start time;
a reverse torque generating part configured to supply a current to the U-phase coil, the V-phase coil, and the W-phase coil and induce generation of a reverse direction torque when the first detection part detects the reverse torque supplying start time;
a second detection part configured to detect whether the DC holeless motor is in a near halt rotation state; and
a forced stopping part configured to forcibly stop rotation of the DC holeless motor when the second detection part detects that the DC holeless motor is in the near halt rotation state.

20. A method for manufacturing a storage device including a recording medium and a motor that rotates the recording medium, the method comprising the steps of:
rotating the motor;
performing a short breaking process on the motor;
exciting the motor and inducing the motor to generate a reverse torque when a rotation speed of the motor reaches a value that is less than or equal to a first predetermined value;
forcibly stopping rotation of the motor when the rotation speed of the motor reaches a value that is less than or equal to a second predetermined value which second predetermined value is less than the first predetermine value; and
performing one or more processes on the storage device after the motor is stopped.

21. A motor drive control method for driving and controlling a motor including plural excitation phases, the method comprising the steps of:
short-circuiting the excitation phases while the motor is rotating;
exciting the motor and inducing the motor to generate a reverse rotation direction torque when a rotation number of the motor reaches a first predetermined value; and
performing forced excitation for a predetermined time period in accordance with a predetermined excitation pattern when the rotation number of the motor reaches a second predetermined value which second predetermined value is less than the first predetermined value.
